(19) United States
(12) Patent Application Publication
(10) Pub. No.: US 2022/0300825 A1
(43) Pub. Date: Sep. 22, 2022

(54) Classification of unknown faults in an electronic-communication system

(71) Applicant: Orange, Issy-Les-Moulineaux (FR)

(72) Inventors: Amine Echraibi, Chatillon Cedex (FR); Joachim Flocon-Cholet, Chatillon Cedex (FR); Stéphane Gosselin, Chatillon Cedex (FR)

(21) Appl. No.: 17/697,472

(22) Filed: Mar. 17, 2022

(30) Foreign Application Priority Data
Mar. 19, 2021 (FR) 2102748

(51) Int. Cl. G06N 3/08

(52) U.S. Cl. CPC G06N 3/088

(57) ABSTRACT

A method for classifying a fault affecting a complex system and belonging to an unknown class. The method is implemented by a neural network and includes: a first step of training the neural network with a first corpus of data representative of faults a known class; a step of extracting hidden data from the neural network, the hidden data being produced with a second corpus of data representative of faults of an unknown class; a step of clustering the extracted hidden data, producing at least one cluster corresponding to a new class of fault; a step of adding at least one new class to the neural network; a second step of training the neural network, with at least one portion of the second corpus corresponding to the at least one added new class; and a step of classifying the fault belonging to the unknown class with the neural network.

### 1. FIELD OF THE INVENTION

The invention relates to the field of machine learning applied to object recognition. More particularly, the invention relates to a type of problem known as “zero shot learning” where the system must learn to recognize objects belonging to classes that are not known during the training phase. More particularly, the invention is applicable to the diagnosis of unknown faults in complex electronic-communication systems or networks.

### 2. PRIOR ART

Up to now, zero-shot learning methods have been used in specific fields of application (image recognition, comprehension of natural language, diagnosis of faults in mechanical/industrial systems). These fields of application are in particular characterized by a high degree of homogeneity in the data processed for training purposes (images for image recognition, sentences for comprehension of natural language, numerical variables for mechanical systems). These methods do not, in particular, allow heterogeneous datasets containing high numbers of numerical, textual and/or categorial variables, which are one of the characteristics of complex systems, to be processed.

One of the aims of the invention is to remedy these drawbacks of the prior art.

### 3. DISCLOSURE OF THE INVENTION

The invention improves the situation by providing a method for classifying a fault affecting a complex system and belonging to an unknown class, the method being implemented by a neural network and comprising:
a first step of training the neural network, with a first corpus of data representative of faults the class of which is known,
a step of extracting hidden data from the neural network, said data being produced with a second corpus of data representative of faults the class of which is unknown,
a step of clustering the extracted hidden data, producing at least one cluster corresponding to a new class of fault,
a step of adding at least one new class to the neural network,
a second step of training the neural network, with at least one portion of the second corpus corresponding to the at least one added new class,
a step of classifying the fault belonging to an unknown class with the neural network.

The claimed method exploits the paradigm of zero-shot machine learning with a view to allowing new classes of faults or malfunctions of a complex system to be identified, this system being characterized by the production of data (variables, alarms, parameters, identifiers, etc.) of high dimensionality (several thousand variables possible) in each of tens or hundreds of thousands of instances of operation of the complex system. The method exploits data available for faults known to specialists, these data instances having already been labeled with classes of known faults, by a diagnostic tool based on specialist rules for example. The method also exploits data instances available for faults unknown to specialists, these data instances not being labeled (root cause of fault unknown). The claimed method thus allows unknown-fault clusters to be discovered in unlabeled data instances, without the number of unknown classes of faults being known in advance.

In one of the implementations of the proposed solution, the machine learning is carried out in one go with a dataset of high dimensionality comprising both instances of known faults (labeled data) and instances of unknown faults (unidentified faults, unlabeled data). The algorithm optimally converts the space in which the data are represented in order to make the most of the specialist knowledge (the labels of known faults) and allows a plurality of clusters corresponding to new classes of faults (unknown faults) to be extracted therefrom.

Other implementations of the method allow the machine learning to be carried out more gradually, with a plurality of iterations of the method carried out on different data corpora, and with decision-making steps regarding the choice of the one or more clusters to preserve in each iteration.

The operation of a complex system, electronic-communication services and networks being only one example of such systems, has the particularity of being governed by a very high number of heterogeneous technical parameters, this making diagnosis of a fault by a human very difficult. The machine learning of the proposed classifying method solves a technical problem that most of the time is insoluble by a human being, even if expert.

The technical parameters are subjected to a preliminary step of preprocessing fault-related data, producing values for numerical variables. The neural network comprises an input layer with at least as many neurons as there are distinct numerical variables.

According to one aspect of the classifying method, the neural network comprises an output layer with at least as many neurons as known classes of faults, and adding a new class means adding a neuron to the output layer.

Thus, the output layer allows classes of faults to be discriminated between, and adapts easily to the increase in the number of distinguishable classes.

According to one aspect of the classifying method, the neural network is a multilayer perceptron and comprises, in addition to the output layer, an input layer and at least one intermediate layer, between the input and output layers.

Among the many types of artificial neural networks usable by the proposed method, the multilayer perceptron (MLP) is very appropriate because its simple structure allows what are referred to as hidden data, i.e. internal data generated by the perceptron between its input and output data, to be easily extracted. Other types of neural network are suitable, with other, linear or non-linear, activation functions, in each neuron for example; all that is required is for the values produced by any one of the intermediate layers to be extractable. Neural networks in general and MLPs in particular also have the advantage of allowing the dimensionality of the space of the raw data to be decreased, thus facilitating clustering.

According to one aspect of the classifying method, a neuron is connected to all the neurons of a preceding or following neighboring layer.

According to one aspect of the classifying method, the hidden data are extracted from the last intermediate layer before the output layer.

When the corpora of known faults are sufficiently rich, the penultimate layer of the MLP is in principle the most interesting from a specialist point of view, because, being closest to the output layer, which represents the classes of known faults, it “incorporates” the rich specialist knowledge associated with known faults. However, the other intermediate layers may be suitable, in particular if there are few known faults. A compromise as to the number of intermediate layers to be used may be explored, depending on the quantity of specialist knowledge already available as a result of known faults.

According to one aspect of the classifying method, from the input layer to the output layer, the size of a layer with respect to the size of a preceding layer is decreased by a factor higher than or equal to 2.

By virtue of this aspect, the proposed method is applicable to complex data of high dimensions, such as the very varied and very many variables describing a fault in an electronic-communication system. Even if the input layer comprises a very high number of neurons, a high number of intermediate layers is not necessary to achieve an output layer comprising a low number of neurons corresponding to a limited number of classes of different faults.

According to one aspect of the classifying method, the clustering step uses a Dirichlet process Gaussian-mixture model.

Cluster inference is advantageously carried out by a combination of an infinite mixture model, based on the Dirichlet process for example, for testing various numbers of clusters, and of a variational-inference process for calibrating, in each cluster, the various distributions of hidden data. This technique does not need to know the number of clusters in advance to work and, compared to other inference methods, such as Markov-chain-Monte-Carlo methods, variational inference has the advantage of making cluster inference more robust to the high dimensionality of the data of the complex system to be diagnosed.

According to one aspect of the classifying method, the adding step is preceded by a step of selecting the at least one new class of fault on the basis of a criterion representative of the relevance of the corresponding cluster.

By virtue of this aspect, it is possible to maintain the quality of the training of the classifier at a certain level by selecting a new class of fault only if the corresponding cluster has a minimum degree of distinction or of independence with respect to the other clusters of classes of known faults. Achievement of this minimum degree is also a criterion of relevance of a class of fault from a specialist point of view, which may be evaluated by a human expert, or automatically via statistical criteria, such as for example informational criteria inherent to the clusters, or the degree of recognition of the classes after retraining including the one or more new classes corresponding to the new clusters discovered.

According to one aspect of the classifying method, following the second training step, at least one cycle of the following steps is carried out:
a new step of extracting hidden data from the neural network, said data being produced with a new second corpus of data representative of faults the class of which is unknown,
a new step of clustering the extracted hidden data, producing at least one cluster corresponding to a new class of fault,
a new step of adding at least one new class to the neural network,
a new second step of training the neural network, with at least one portion of the new second corpus corresponding to the at least one added new class.

Thus, the discovery of new classes of fault is gradual, this allowing the method to handle the corpora of data representative of faults the class of which is unknown becoming available only gradually. In addition, it is thus possible to discover intermediate representation spaces that allow the hidden data to be discriminated between by clustering more effectively.

According to one aspect of the classifying method, a single new class of fault is selected after a clustering step.

Thus, when a plurality of clusters are discovered, it is possible to retain only the cluster which is liable to be the most reliable or the most relevant. When a plurality of extracting/clustering/adding/training cycles are carried out, identifying a single new class of fault per cycle has the advantage of making the successive corpora of unknown fault data more homogeneous, and of making the clustering steps more effective.

The invention also relates to a classifying device comprising a neural network, for classifying a fault affecting a complex system and belonging to an unknown class, the device further comprising an input interface for data representative of faults, an output interface for information relative to a class of fault, at least one processor and at least one memory, the latter being coupled to the at least one processor, storing instructions that when executed by the at least one processor lead the latter to implement the following operations:
training the neural network, with a first corpus of data representative of faults the class of which is known,
extracting hidden data from the neural network, said data being produced with a second corpus of data representative of faults the class of which is unknown,
clustering the extracted hidden data, producing at least one cluster corresponding to a new class of fault,
adding at least one new class to the neural network,
training the neural network, with at least one portion of the second corpus corresponding to the at least one added new class,
classifying the fault belonging to an unknown class with the neural network.

This device, which is able to implement all the embodiments of the classifying method that has just been described, is intended to be implemented in one or more computers.

The invention also relates to a computer program comprising instructions that, when these instructions are executed by a processor, result in the latter implementing the steps of the classifying method just described above.

The invention also targets a computer-readable data medium comprising instructions of a computer program, such as mentioned above.

The program mentioned above may use any programming language, and be in the form of source code, object code, or of intermediate code between source code and object code, such as in a partially compiled form, or in any other desirable form.

The aforementioned data medium may be any entity or device capable of storing the program. For example, a medium may include a storage means, such as a ROM, for example a CD-ROM or a microelectronic circuit ROM, or else a magnetic recording means.

Such a storage means may be for example a hard disk, a flash memory, etc.

Moreover, a data medium may be a transmissible medium such as an electrical or optical signal, which may be routed via an electrical or optical cable, by radio or by other means. A program according to the invention may in particular be downloaded from an Internet network.

Alternatively, a data medium may be an integrated circuit in which a program is incorporated, the circuit being designed to execute or to be used in the execution of the method in question.

### 4. PRESENTATION OF THE FIGURES

Other advantages and features of the invention will become more clearly apparent on reading the following description of one particular embodiment of the invention, which embodiment is given by way of simple illustrative and non-limiting example, and the appended drawings, in which:

FIG. 1 illustrates an example of implementation of the classifying method, according to a first embodiment of the invention,

FIG. 2 illustrates an example of implementation of the classifying method, according to a second embodiment of the invention,

FIG. 3 shows in 2D data corresponding to unknown classes according to one embodiment of the invention,

FIG. 4 shows in 2D the same unknown data according to a prior-art technique,

FIG. 5 illustrates one example of a structure of a classifying device, according to one aspect of the invention.

### 5. DETAILED DESCRIPTION OF AT LEAST ONE EMBODIMENT OF THE INVENTION

The solution proposed here exploits the paradigm of zero-shot machine learning with a view to allowing new classes of faults or malfunctions of a complex system to be identified, this system being characterized by the production of heterogeneous data (numerical variables, alarms, parameters, identifiers, text fields, etc.) of high dimensionality (several thousand variables possible) for each of tens or hundreds of thousands of instances of faults in the complex system (one instance being defined as all of the contextual data that was able to be collected with a view to diagnosing one particular fault). The proposed solution assumes that data instances are available for each fault known to specialists, these data instances having already been labeled with classes of known faults, for example by an expert system based on specialist rules (such an expert system commonly being implemented by entities or companies employing said complex system to deliver resources or services to their users or customers). The proposed solution also assumes that data instances are available for unknown faults, which will therefore not have been able to be labeled as a result of a lack of specialist knowledge on these data instances. As the diagnostic tools commonly used on complex systems do not allow all possible faults to be diagnosed, the solution proposed here is an advantageous complement thereto, in that it allows faults previously unknown to specialists to be identified.

The general principle of the proposed solution consists in learning how to optimally convert the space in which the data are represented, in order to make the most of specialist knowledge (the labels of known faults), with a view to subsequently performing an exploratory analysis of the data allowing clusters of unknown faults to be found (the word infer is also used) in the unlabeled data. The result of the exploratory analysis is thus a segmentation of the unlabeled data into a plurality of clusters of unknown faults, the number of these unknown classes not necessarily being set in advance.

The proposed solution receives as input a high number of fault data instances, each fault data instance consisting of a high number of heterogeneous variables, and the fault labels of instances of faults that are known. This set of initial data is first preprocessed, with prior-art preprocessing operations:
either numerical variables are discretized with a view to converting them into categorial variables, and text fields are converted into categorial variables. A categorial variable is defined here as a variable that is able to take its values from a finite set of values called categories, such as for example “pear”, “banana” or “apple”;
or the numerical variables are recentered and normalized, textual fields are converted into categorial variables, then all the categorial variables are converted into binary variables, which are then processed as numerical variables. A categorial variable is converted into binary variables using one-hot encoding: a categorial variable able to take N different values is replaced by N binary variables equal to 1 or 0 depending on the category value.

Which of the above two preprocessing operations is used depends on whether the variant machine-learning method employed works with categorial data or numerical data.

Specifically, by virtue of the labels of instances of known faults, the proposed solution learns to mathematically convert the initial data space into a converted data space, which expresses the statistical similarity between the instances of known faults having the same label. The aim of the exploratory analysis of the data space thus converted is to find (the word infer is also used) various clusters that will each represent one class of unknown fault and/or that will reproduce the classes of known faults. This inference of clusters of faults may be carried out using various clustering methods, and for example using infinite mixture models coupled with variational inference or inference via a Markov-chain-Monte-Carlo method. Infinite mixture models have the advantage of not requiring the number of clusters to be found to be set in advance: they allow the number of clusters of unknown faults to be determined automatically, and are therefore suitable for diagnosing faults in complex systems.

The mathematical conversion of the data space, which conversion is learnt based on the specialist knowledge represented by the labels of the instances of known faults, allows the proposed solution to segment all of the instances of unlabeled data in a way that is relevant to the underlying issue of fault diagnosis. As the proposed solution in addition uses the infinite-mixture-model technique, it allows the number of clusters of unknown faults to be determined automatically.

Firstly, preprocessed instances of labeled data are used to train a classifier, i.e. a mathematical conversion allowing the labels of known faults to be recognized. This step involves supervised learning based on the labels of known faults. The instances of converted data are not the labels as such, but instances of converted data referred to as hidden data, which reflect what are considered to be “specialist” characteristics of the initial data. Many different techniques may be used in this step, which results in a linear or non-linear conversion of the data. Neural networks are the most widely known examples of techniques for obtaining such a non-linear conversion, neural networks themselves coming in a high number of possible variables.

Next, the instances of unlabeled data are projected into the converted data space, using the above learnt conversion. This allows another data space, reflecting the “specialist” characteristics of the initial data on the classes of known faults, to be worked in.

Lastly, clusters of unknown faults are inferred from instances of unlabeled data, but working on the converted data and not on the initial data. The inference of the clusters is carried out by combining an infinite mixture model, for example based on the Dirichlet process, and a variational-inference method, which advantageously converts the inference problem into an optimization problem. Compared to other inference methods, such as Markov-chain-Monte-Carlo methods, variational inference has the advantage of making cluster inference more robust to the high dimensionality of the data of the complex system to be diagnosed.

The proposed method has been tested with real data originating from the network of an operator providing Internet access to millions of customers. The data corpus used contained the technical data of 64 279 customers equipped with FTTH Internet access. The customer instances were classified into 8 classes of known faults, including a special class for normal operation (fault-free, 19 604 instances). The 7 other known classes in this corpus were:
fiber cut (18 282 instances)
fiber degraded (6906 instances)
problem of interoperability between the optical network terminal (ONT) and the
residential gateway (6782 instances)
problem with residential-gateway update (6050 instances)
poor residential-gateway configuration (3732 instances)
customer account deleted (1527 instances)
TV problem (1396 instances).

Each customer data instance comprised 1824 characteristics or variables specific to various portions of the network and characterizing the state of the line of the customer. These variables may be of all types (text fields, categorial variables, numerical variables). Among these 1824 variables, the properties of the FTTH GPON were for example described by 652 variables, the properties of the residential equipment (gateway, set-top box, etc.) by 446 variables, the properties of TV and VolP services by 204 variables, the properties of the Internet session (DHCP) by 256 variables, and the properties of the customer profile by 41 variables. These 1824 variables were preprocessed and converted into 8297 numerical or binary variables (the latter themselves being considered to be numerical variables), as explained above.

Moreover, this first corpus of 64 279 data instances classified into 8 classes of known faults, which corpus is called C1 below, was completed by a second corpus of 21 960 data instances representative of unknown faults, which corpus is called C2 below. As for the first corpus, each data instance of the second corpus comprised 1824 variables of all types, preprocessed and converted into 8297 numerical or binary variables (the latter themselves being considered to be numerical variables), as explained above.

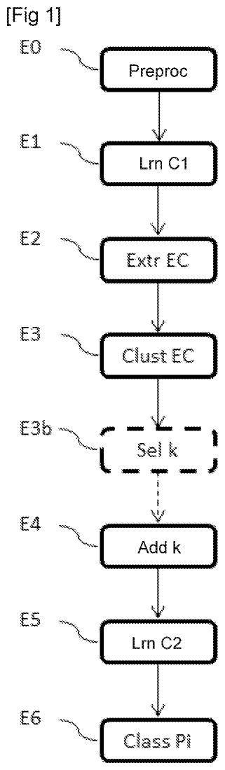

FIG. 1 illustrates an example of implementation of the classifying method, according to a first embodiment of the invention.

The goal of the method is to classify an unlabeled fault instance Pi into a category or class of fault, when this instance belongs to none of the initially known classes. It is assumed that the method receives a certain number of unlabeled instances of faults of the same unknown class as Pi.

In a step E0, the data instances representing faults are preprocessed using one of the known methods described above. A first corpus of preprocessed data, which is denoted C1, contains instances of known and labeled faults, each label identifying a known fault biunivocally. Each known fault instance in C1 consists of a fault label Lp and of a vector of Nvp variables, Nvp being the number of variables (after the preprocessing E0) characterizing a fault. The number of different labels of known faults is denoted Npc. For example, a known-fault label is an integer number taking a value between 1 and Npc. A second corpus of preprocessed data, which is denoted C2, comprises instances of unknown and unlabeled faults. In C2, and generally for any unlabeled fault instance, the fault label Lp may for example take the value zero (or any other negative value chosen to represent an unknown class; here, purely by convention, strictly positive values have been reserved for known-fault labels).

In a step E1, the instances of preprocessed labeled data, i.e. the instances of the corpus C1, or of one portion of the corpus C1, are used to train the mathematical conversion of the classifier allowing known-fault labels to be recognized. This step involves supervised learning based on the labels of known faults.

For example, the classifier is a multilayer perceptron (MLP) type of neural network, the structure of which comprises an input first layer of Nvp neurons, one or more intermediate layers of neurons, and an output last layer of Npc neurons. The number of intermediate layers and the number of neurons per intermediate layer are determined by rules of good practice: typically, the dimensionality (number of neurons per layer) may decrease by a factor of 2 from one layer of the neural network to the next. By way of example, with the corpus C1 described above, the neural network used comprises four intermediate layers the number of neurons in which is 2000, 1000, 500 and 100, respectively, the first layer comprising Nvp=8297 neurons and the last layer comprising Npc=8 neurons. The objective is thus to achieve a decrease in dimensionality in order to obtain an Niex (number of neurons in the last intermediate layer) that is very much lower than Nvp (number of variables in the initial space). Other numbers of intermediate layers and numbers of neurons in each layer may of course be chosen without the performance of the neural network being significantly affected thereby. The MLP is trained with the corpus C1, or one portion of the corpus C1, using a known technique (gradient descent with back-propagation algorithm), until an acceptable recognition rate (at least 90%) is obtained on instances of known faults, which will potentially not belong to the corpus C1 or belong to a portion of the corpus C1 that was not used in training.

In a step E2, the instances of the corpus C2, or one portion of the corpus C2, are input into the MLP trained in step E1 and instances of converted data, which are also called hidden data, are extracted from the MLP. More precisely, for each of these instances of unlabeled unknown faults input into the MLP, the values output by the neurons of the penultimate layer of the MLP, or in other words of its last intermediate layer, are extracted to form a set, denoted EC, of vectors of size Niex, Niex being the number of neurons in the last intermediate layer of the MLP.

In a step E3, the instances of unlabeled unknown faults are grouped into clusters. More precisely, new clusters of faults, the number of which is denoted K, are inferred from the set EC of vectors of size Niex, i.e. from the converted data extracted from the last intermediate layer of the MLP when instances of the corpus C2 are input into the input layer of the MLP.

This clustering is performed, without knowing in advance the number of clusters, by a combination of a Dirichlet process for testing various numbers of clusters, and of a variational-inference process for calibrating, in each cluster, the various distributions of vectors of size Niex. Such a technique is described, in the case of categorial variables, in the article “An Infinite Multivariate Categorical Mixture Model for Self-Diagnosis of Telecommunication Networks” 2020 23rd Conference on Innovation in Clouds, Internet and Networks and Workshops (ICIN), Paris, France, 2020, pp. 258-265. This technique is also implementable in the case of numerical variables, to process data the distribution of which is Gaussian, this not necessarily being the case of the raw data even after preprocessing, but being expectable of the converted data contained in the corpus C2. The Dirichlet process Gaussian-mixture model (DP-GMM) is spoken of in this case.

In a step E4, the classifier is altered by adding new classes to the initial set of the known classes 1, . . . , Npc. Two choices may be made in this step: either all of the K clusters of unknown faults discovered in step E3 are respectively associated with new labels of known faults Npc+1, . . . , Npc+K, or only some of these clusters are associated with new labels of known faults Npc+1, . . . , Npc+k, k being an integer comprised between 1 and K−1 inclusive. With respect to the second choice, the selection, in a step E3b, of the clusters to be considered as new classes of known faults may be made following a statistical analysis—and/or by a specialist on the complex system to be diagnosed—of the clusters discovered in step E3, so as to retain as new known faults only clusters judged to be extremely relevant from a specialist point of view. In both cases, the structure of the MLP is modified so that its output layer contains Npc+k neurons, by adding k new neurons, k representing the number of new classes of known faults, and being an integer comprised between 1 and K inclusive.

In a step E5, labels are attributed to the k precedingly identified clusters, and each fault instance of the corpus C2, provided that it is present in a cluster retained in step E4, receives the label of the cluster in which the instance was placed in the step E3 of clustering. The new labels Lp are for example numbered from Npc+1 to Npc+k, as indicated in the description of step E4. The second corpus C2 is thus modified into a corpus C2′, by removing therefrom where appropriate all the instances not present in a cluster retained in step E4, and by attributing values of newly discovered labels to the labels Lp the initial value of which was lower than or equal to zero (corresponding to an unknown class). These new values correspond to faults that are new with respect to the known faults Npc of the corpus C1, and grouping them into clusters makes it easier for an expert, whether a human or a robot, to make a diagnosis. Next, in this step E5, the classifier altered in step E4, i.e. the modified MLP, is trained with the data of the corpora C1 and C2′ combined.

Finally, in a step E6, the fault instance Pi, of class previously unknown and not belonging to the corpus C2, is input into the modified and retrained classifier, this allowing the previously unknown fault label of the instance Pi that will be output from the classifier to be predicted. It will be understood that by virtue of the proposed method, any instances of faults of previously unknown and unlabeled class may be correctly classified in one of the k new classes retained in step E4.

The proposed classifying method allows a high variety of machine-learning methods to be used, whether in step E1 of training and converting the data space, which may be carried out with a supervised learning technique allowing access to the hidden data, or in step E3 of clustering unlabeled data, which may be carried out with an unsupervised learning technique.

Advantageously, this method allows the following to be processed independently: (i) the incorporation of specialist knowledge, which is done by taking into account instances of known faults and the corresponding labels in the corpus C1, and (ii) the discovery of clusters of unknown faults among the instances of unlabeled data of the corpus C2, this discovery greatly benefiting the data conversion carried out in step E2.

In the example that has just been described, step E1, which is also a step of training the data conversion of step E2, uses only instances of labeled data (corpus C1), and therefore does not integrate the statistical characteristics of the instances of unlabeled data (corpus C2); however, this would allow the machine learning to be enriched. This first embodiment of the proposed method is therefore particularly appropriate when the corpus C1 is of large size, and very highly representative of the diversity of the possible faults of the complex system to be diagnosed, and when a lower number of fault instances (corpus C2) correspond to unknown faults.

In a second embodiment of the proposed method, integration of the statistical characteristics of the instances of unlabeled data (corpus C2) is approached by gradually incorporating a plurality of corpora of the type of C2 (or a plurality of portions of the initial corpus C2 if its size allows) into it, by means of a plurality of iterations of steps E0 to E4 of the classifying method. At the end of each iteration, new classes are added to the known classes, the corpus C2′ (i.e. a labeled portion of the corpus C2, or the entirety of the labeled corpus C2) is added to the corpus C1 and the following iteration uses a new corpus C2 and/or the portion of C2 that was not labeled, and the iterations are repeated until all the corpora C2 have been incorporated.

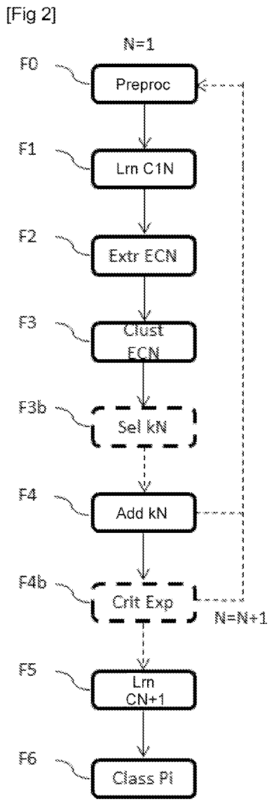

FIG. 2 illustrates an example of implementation of the classifying method, according to a second embodiment of the invention.

Specifically, based on corpora C1 and C2 such as described in the first embodiment, the steps of an iteration N of this second embodiment will be described below.

The sole particularity of the first iteration N=1 is that the corpora C1N−1 and C2N−1 mentioned in step F0 are considered to be empty corpora. The steps of each iteration are therefore described generically, for any iteration denoted N.

In a step F0 of iteration N, new corpora C1N and C2N are formed then, if they have not already been, are preprocessed in the same way as in step E0 described above.

The corpus C1N may combine a choice of a plurality of portions: (i) a portion or the entirety of the corpus C1N−1 that was used in the preceding iteration N−1; (ii) a portion of the initial corpus C1 that was not used in the preceding iteration N−1; (iii) instances of known faults recently obtained during operation of the complex system to be diagnosed, and the fault labels of which were for example generated by an expert system based on specialist rules; (iv) a portion of the clusters discovered in C2N−1, in the clustering step of the preceding iteration N−1, these clusters being labeled with the new fault labels discovered in this iteration N−1. This approach to forming the corpus C1N makes it possible to incorporate, in the first iterations, only classes of known faults that are largest in terms of members or highest in terms of specialist relevance, then, as the iterations proceed, to completely represent all the classes of known faults, then previously unknown faults that have become classes of known faults in the successive iterations. The corpus C2N may combine a choice of a plurality of portions: [i] a portion of the clusters that were discovered in C2N−1 in the clustering step of the preceding iteration N−1 and that were not considered to be new classes of known faults in this iteration N−1. This portion of C2N−1 is disjoint from the portion of C2N−1 used in C1N according to (iv); [ii] a portion of the initial corpus C2 that was not used in the preceding iteration N−1; [iii] instances of unknown faults recently obtained during operation of the complex system to be diagnosed, and that have been unable to be classified into classes of known faults. This approach to forming the corpus C2N allows, as the iterations proceed, to gradually introduce the newness of instances of unknown faults, insofar as these instances may have, from a specialist point of view, an atypical character, which could disrupt the discovery of new classes of faults that are relevant from a specialist point of view.

In a step F1 of iteration N, the corpus C1N is used to train the mathematical conversion of the classifier allowing the labels of known faults to be recognized. This step involves supervised learning based on the labels of known faults, and is equivalent to step E1 of the first embodiment, with the exception that training is here carried out using the corpus C1N constructed in step F0 of iteration N.

In a step F2 of iteration N, the instances of the corpus C2N are input into the MLP trained in step F1 of iteration N and instances of converted data, which are also called hidden data, are extracted from the MLP. This step is equivalent to step E2 of the first embodiment, with the exception that the instances input into the MLP are obtained from the corpus C2N constructed in step F0 of iteration N. The set of these instances of converted data, which set is generated in this step F2, is called ECN.

In a step F3 of iteration N, the instances of unlabeled unknown faults are grouped into clusters. More precisely, new clusters of faults, the number of which is denoted KN, are inferred from the set ECN of vectors of size Niex, i.e. from the converted data extracted from the last intermediate layer of the MLP when the instances of the corpus C2N are input into the input layer of the MLP. This step is equivalent to step E3 of the first embodiment, with the exception that the new clusters of faults are inferred from the set ECN.

In a step F4 of iteration N, the classifier is altered by adding new classes to the set of classes of known faults that is generated in iteration N−1. This set of classes of known faults that is generated in iteration N−1 comprises the classes of faults known initially (before the first iteration) and all the classes of previously unknown faults added as classes of known faults in step F4 of the preceding iterations 1, . . . , N−1. As regards the addition of new classes in this iteration N, two choices are possible: either all of the KN clusters of unknown faults discovered in step F3 are associated with new known-fault labels, or only some of these clusters are associated with new known-fault labels. With respect to the second choice, the selection, in a step F3b, of the clusters to be considered as new classes of known faults may be made following a statistical analysis—and/or by a specialist on the complex system to be diagnosed—of the clusters discovered in step F3, so as to retain as new known faults only clusters judged to be extremely relevant from a specialist point of view. This selection of relevant clusters is especially important in the first iterations, as it guarantees the reliability of the specialist knowledge incorporated by way of these new classes of known faults in these steps F4. It is especially judicious, in the first iterations, to add only a single new class of faults per step F4. In all cases, the structure of the MLP is modified so that its output layer contains kN new neurons, kN representing the number of new classes of known faults, and being an integer comprised between 1 and KN inclusive.

Step F4 described above ends iteration N of this second embodiment, and makes it possible to employ, in the following iteration, a modified MLP structure taking into account not only new classes of known faults in its output layer, but also clusters of previously unknown faults that have now been identified as classes of known faults, consistently with the modification of the structure of the MLP. The following iteration N+1 then begins, in step F0, with formation of new corpora C1N+1 and C2N+1.

On account of the many possibilities as regards formation of the corpora C1N and C2N, steps F0 to F4 may be iterated a high number of times, no precise termination criterion being employed. However, it is important to note that step F4 may incorporate a step F4b of making a decision as regards continuation of the iterations. This decision-making step F4b determines whether the iterative process must fork, i.e. end or not, to a step of classifying a particular fault of unknown class. It is moreover possible to end the iterations when all the available corpora C2 have been exhausted in the process of discovering new classes of faults. Step F4b may be based on the statistical analysis of step F3b, and be automated using an expert system, or carried out by a human expert, optionally assisted by the expert system. It is also possible for this step to be based on step F1 of the following iteration N+1, in which an unsatisfactory degree of recognition (i.e. a degree of recognition lower than a given threshold) of the new set of known-fault labels (the corpus C1N+1) may be due to a suboptimal selection of the new clusters in the step F3b of the current iteration N. The method may then return to this step F3b of iteration N in order to correct the selection, either manually, or using a preestablished correctional selection rule (for example one that selects a lower number of clusters corresponding to a new class, or that selects one or more others).

So as to be able to classify, at any moment, a fault instance Pi of previously unknown class, step F4 or F4b of iteration N may be followed directly (in parallel with a new iteration N+1) by retraining of the MLP, in a step F5 equivalent to step E5 of the first embodiment, and classification of the fault instance Pi, in a step F6 equivalent to step E6 of the first embodiment, to predict its previously unknown fault label, which is however now known after the N iterations of this second embodiment.

In these steps F5 and F6, the data corpora used are then the corpora C1N and C2′N, the latter corpus being defined in a way equivalent to the corpus C2′ of step E5, but starting with the corpus C2N. In method terms, steps F5 and F6 form a fork allowing the loop formed by steps F0 to F4 to be exited from, and finally allow any fault instance of previously unknown and unlabeled class to be correctly classified into one of the new fault classes gradually obtained in the successive iterations of steps F0 to F4.

In one variant of this second embodiment, when no corpus C1 of labeled data is available, the first iteration, after preprocessing of the initial corpus C2 in step F0, then passes directly to step F3 in which one portion or all of the preprocessed initial corpus C2 is clustered, neither the training of F1 nor the data conversion of step F2 being carried out.

Advantageously, this second embodiment allows the machine learning to be enriched by gradually integrating the statistical characteristics of the instances of unknown faults. The mathematical conversion learnt in step F1 is thus increasingly representative of all of the specialist characteristics of the data used, as the iterations proceed. This second embodiment of the proposed method is therefore especially appropriate when the initial corpus C1 is of modest size, or not very representative of the diversity of the possible faults of the complex system to be diagnosed, and when a high number of fault instances (initial corpus C2) correspond to unknown faults. This second embodiment may nevertheless also be entirely appropriate in an operational context of exploitation of the complex system to be diagnosed, because it allows an incremental and gradual improvement in the diagnosing method that preserves the reliability of the diagnoses and decreases the number of instances of unknown faults.

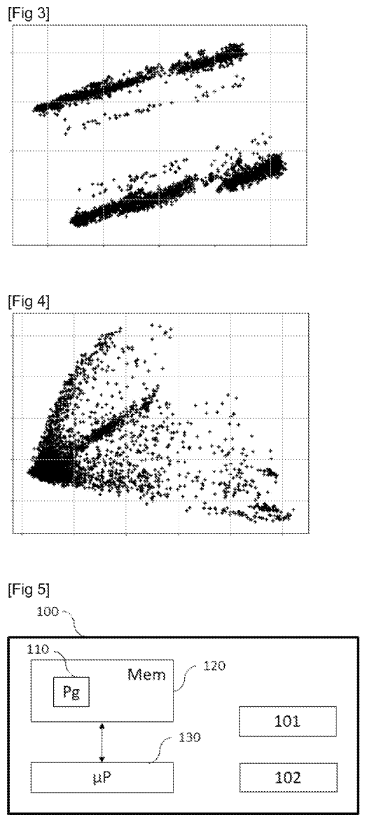

By way of illustration of the effectiveness of the proposed classifying method, FIGS. 3 and 4 show a comparison between an exploration carried out by virtue of the claimed method, and an exploration of unsupervised type used in the prior art.

Initially, steps E0 and E1 were carried out, in which steps a neural network was trained using a corpus (C1) of labeled data that was composed of 64 279 instances distributed between 8 classes. The corpus C1 was preprocessed and converted into 8297 numerical variables. The neural network used here was composed of 4 intermediate layers the number of neurons in which was 2000, 1000, 500 and 100, respectively. The activation function used in the neurons was the ReLU activation function (ReLU being the acronym of Rectified Linear Unit).

FIG. 3 shows the projection of unknown data (corpus C2) onto the hidden penultimate layer of the neural network (step E2). At this stage, it may clearly be seen that there are two clearly distinct populations suggesting two different types of fault. After interpretation, it turned out that, of the two fault behaviors, one was related to a problem between the ONT and the residential gateway, and the other to a problem in the GPON (passive optical network).

By way of comparison, FIG. 4 illustrates a representation of the same data (corpus C2) but exploited according to a known technique, i.e. in the original space composed of 8297 variables. This representation was obtained using an unsupervised exploratory approach. Here, no specialist knowledge was incorporated and it may be seen that clusters are difficult to identify clearly.

With reference to FIG. 5, an example of a structure of a classifying device according to one aspect of the invention will now be presented.

The selecting device 100 implements the classifying method, various embodiments of which have just been described.

Such a device 100 may be implemented in one or more computers.

For example, the device 100 comprises an input interface 101, an output interface 102, a processing unit 130, equipped for example with a microprocessor μP, and controlled by a computer program 110, stored in a memory 120 and implementing the classifying method according to the invention. On initialization, the code instructions of the computer program 110 are for example loaded into a RAM memory, before being executed by the processor of the processing unit 130.

Such a memory 120, such a processor of the processing unit 130, such an input interface 101 and such an output interface 102 are able to and configured so as to:
train a neural network, with a first corpus of data representative of faults the class of which is known,
extract hidden data from the neural network, said data being produced with a second corpus of data representative of faults the class of which is unknown,
cluster the extracted hidden data, producing at least one cluster corresponding to a new class of fault,
add at least one new class to the neural network,
train the neural network, with at least one portion of the second corpus corresponding to the at least one added new class,
classify the fault belonging to an unknown class with the neural network.

The entities or modules described with reference to FIG. 5 and comprised in the classifying device may be hardware entities or modules or software entities or modules. FIG. 5 illustrates just one particular way from among several possible ones of implementing the algorithm described above with reference to FIGS. 1 and 2.

Specifically, the technique of the invention is carried out indiscriminately on a reprogrammable computing machine (a PC, a DSP processor or a microcontroller) executing a program comprising a sequence of instructions, or on a dedicated computing machine (for example a set of logic gates such as an FPGA or an ASIC, or any other hardware module), or on a virtual container or a virtual machine that are hosted in a reprogrammable computing machine or in a cloud.

If the invention is installed on a reprogrammable computing machine, the corresponding program (that is to say the sequence of instructions) may be stored in a removable storage medium (such as for example a USB stick, a floppy disk, a CD-ROM or a DVD-ROM) or a non-removable storage medium, this storage medium being able to be read partly or fully by a computer or a processor.

1. A method for classifying a fault affecting a complex electronic-communication system and belonging to an unknown class of fault, the method being implemented by a device comprising a neural network and comprising:
training the neural network with a first corpus of data representative of faults of at least one known class,
extracting data converted by the neural network, wherein the extracted data are called hidden data and are produced with a second corpus of data representative of faults of at least one unknown class,
clustering the extracted hidden data, producing at least one cluster corresponding to a new class of fault,
adding at least one of the at least one new class of fault to the neural network,
training the neural network with at least one portion of the second corpus corresponding to the at least one added new class, and
classifying the fault belonging to an unknown class with the neural network.

2. The method as claimed in claim 1, wherein the neural network comprises an output layer with at least as many neurons as known classes of faults, and wherein adding a new class means adding a neuron to the output layer.

3. The method as claimed in claim 2, wherein the neural network is a multilayer perceptron and further comprises an input layer and at least one intermediate layer, between the input and output layers.

4. The method as claimed in claim 3, wherein the hidden data are extracted from a last intermediate layer before the output layer.

5. The method as claimed in claim 3, wherein, from the input layer to the output layer, a size of a layer with respect to a size of a preceding layer is decreased by a factor higher than or equal to 2.

6. The method as claimed in claim 1, wherein the clustering uses a Dirichlet process Gaussian-mixture model.

7. The method as claimed in claim 1, wherein adding is preceded by selecting the at least one new class of fault if the corresponding cluster has a minimum degree of distinction or of independence with respect to the other clusters of known classes of faults.

8. The method as claimed in claim 1, comprising, following the training of the neural network with the at least one portion of the second corpus, performing at least one cycle of the following:
a new step of extracting hidden data from the neural network, said hidden data being produced with a new second corpus of data representative of faults of at least one unknown class,
a new step of clustering the extracted hidden data, producing at least one cluster corresponding to a new class of fault,
a new step of adding at least one of the at least one new class of fault to the neural network, and
a new second step of training the neural network, with at least one portion of the new second corpus corresponding to the at least one added new class.

9. The method as claimed in claim 1, wherein a single new class of fault is selected after the clustering.

10. A device comprising:
a neural network, for classifying a fault affecting a complex electronic-communication system and belonging to an unknown class of fault;
an input interface for receiving data representative of faults;
an output interface for outputting information relative to a class of fault;
at least one processor; and
at least one memory coupled to the at least one processor, storing instructions that when executed by the at least one processor configure the at least one processor to implement the following operations:
training the neural network, with a first corpus of data representative of faults of at least one known class,
extracting data converted by the neural network, wherein the extracted data are called hidden data and are produced with a second corpus of data representative of faults at least one unknown class,
clustering the extracted hidden data, producing at least one cluster corresponding to a new class of fault,
adding at least one of the at least one new class of fault to the neural network,
training the neural network, with at least one portion of the second corpus corresponding to the at least one added new class, and
classifying the fault belonging to an unknown class with the neural network.

11. A non-transitory computer-readable data medium comprising instructions of a computer program stored thereon which, when executed by at least one processor, configure the at least one processor to classify a fault, which affects a complex electronic-communication system and belongs to an unknown class of fault, by implementing operations comprising:
training a neural network with a first corpus of data representative of faults of at least one known class,
extracting data converted by the neural network, wherein the extracted data are called hidden data and are produced with a second corpus of data representative of faults of at least one unknown class,
clustering the extracted hidden data, producing at least one cluster corresponding to a new class of fault,
adding at least one of the at least one new class of fault to the neural network,
training the neural network with at least one portion of the second corpus corresponding to the at least one added new class, and
classifying the fault belonging to an unknown class with the neural network.
